(19) United States
(12) Patent Application Publication
(10) Pub. No.: US 2005/0239017 A1
(43) Pub. Date: Oct. 27, 2005

(54) Ring-shaped illuminated mouth prop

(76) Inventor: Ki B. Lim, San Jose, CA (US)

Correspondence Address: Donald W. Meeker;Patent Agent, 924 East Ocean Front #E, Newport Beach, CA, 92661, US

(21) Appl. No.: 10/830,911

(22) Filed: Apr. 23, 2004

(51) Int. Cl. A61C 5/00

(52) U.S. Cl. 433/140; 433/29

(57) ABSTRACT

A minimal thin ring has an outer concave recess around the outside of the perimeter for receiving the teeth and a large circular central opening. A metal reinforced plastic frame has a removably attachable annular micro fluorescent light on a side facing into the mouth. An outer sanitized replaceable rubber guard surrounds the frame for contact with the teeth.

### BACKGROUND OF THE INVENTION

1. Field of the Invention

The present invention relates to dental bite blocks used in maintaining the mouth of a patient in an open position during a dental procedure and particularly to a mouth prop comprising a thin ring, configured for a wide range of mouth sizes, having an outer concave trough for receiving the teeth and a large circular central opening encircled by a metal reinforced plastic frame with an annular micro fluorescent light attached to an inward facing side of the frame and an outer sanitized replaceable rubber guard that surrounds the frame.

2. Description of the Prior Art

When a dentist performs a dental procedure, it is often helpful for the patient's mouth to be held open to provide access to the patient's teeth. Some procedures, such as a simple examination or teeth cleaning, the patient may be able to open his mouth wide and long enough for the dentist or hygienist to perform the dental procedure. However, in longer and more complex procedures, the patient may tire from holding his or her mouth open or, in the alternative, be unable to hold his or her mouth open due to the pain of the dental procedure or numbness resulting from the anesthesia. For these types of procedures, dental mouth props may be used in an effort to mechanically maintain the patient's mouth in the open position.

Large bright high wattage lamps used by dentists use much electricity and are not able to light the mouth adequately because of the teeth and hands of the dentist or hygienist shadowing the light. They create heat and produce a glare in the eyes of the patient.

Most prior art biting blocks impair the view of the teeth to be worked on by a dentist and generally don't light up the entire mouth of the patient.

U.S. Pat. No. 6,332,776, issued Dec. 25, 2001 to Martin, puts forth a lighted dental prop comprising a wedge shaped bite block and a light source. The bite block utilizes reflected fiberoptic light or an internal light source to provide broad illumination to the mouth.

U.S. Pat. No. 5,462,435, issued Oct. 31, 1995 to Young, concerns an adjustable mouth prop for holding a dental patient's mouth open during performance of a dental procedure in a manner which is safe and comfortable for the patient and convenient for the dentist. The adjustable mouth prop comprises a threaded shaft formed of rigid material suitable for sterilization, the shaft having an enlarged head formed on one end thereof. Upper and lower arms formed of rigid material suitable for sterilization are mounted on the threaded shaft and project outwardly from the threaded shaft. The distal end of the arms have integral elongated concave jaw support members extending laterally thereacross. The jaw support members are engagable with the patient's teeth such that the teeth are removedly retained irrespective of the angles of the arms. The adjustable mouth prop further includes adjustable locking member whereby the user may lock the arm members at a selected angular position relative to each other to prop open the patient's mouth. Sterile cushioning pad members are disposed over the jaw support members. The cushioning pad members comprises an outer elastic covering removably stretched over the jaw support member and a resilient molding material disposed within the covering filling the cavity of the jaw support member to comfortably and securely contact a patient's teeth. The adjustable mouth prop may additionally include a light source attached to the lower arm to illuminate the mouth of the patient. U.S. Pat. No. 1,122,086, issued Dec. 22, 1914 to Dunlop, provides a combined mouth prop and illuminator, which comprises a body pivotally mounted upon a saddle member, said saddle member being adapted to straddle the teeth of the patient. A rest is adjustably mounted on the body member and is also adapted to engage the patient's teeth. A miniature electric lamp or bulb is mounted in the body and means is provided for supplying current to said bulb. The body may turn in relation to the saddle and the rest.

U.S. Patent Applications #20030143512 published Jul. 31, 2003, #20030134253 published Jul. 17, 2003, and #20020039715 published Apr. 4, 2002, and U.S. Pat. No. 6,575,746 issued Jun. 10, 2003, U.S. Pat. No. 6,338,627 issued Jan. 15, 2002, and U.S. Pat. No. 6,022,214 issued Feb. 8, 2000 all to Hirsch put forth an intraoral illumination device and method for illuminating the interior cavity of a patient's mouth during a medical procedure. The illumination device includes a bite block adapted to be engaged by a patient's teeth for resting the patient's jaw during the medical procedure and fixing the bite block within the patient's mouth. An arcuate light dispersion piece is connected to the bite block so that, in use, the light dispersion piece is orientated in a rear, central part of the oral cavity of the patient's mouth so that dispersed light can be transmitted outward from the rear, central part of the oral cavity. A tongue and cheek retractor is adapted to retract and protect the patient's tongue and adjacent cheek tissue during the medical procedure. Multiple fluid evacuation channels are carried by the device and are adapted to communicate with the interior cavity of the patient's mouth for removing fluids from the oral cavity during the medical procedure.

U.S. Pat. No. 6,267,591, issued Jul. 31, 2001 to Barstow, describes a dental prop, throat dam and retractor. The dental device includes a tongue-retracting surface and a throat dam adapted to be positioned in the mouth of a patient. Integral lip-retracting surfaces and a grip portion are connected to the tongue-retracting surface and throat dam by a prop portion which preferably have angled biting surfaces adapted to be engaged by the teeth of the patient. An expandable throat barrier net may be attached to a portion of the throat dam. An evacuation system may be provided to remove fluids from the mouth. The biting surfaces may be provided with a pad or a thermoplastic material for the comfort of the patient. A reflective material may be attached to the tongue-retracting surface and a fiber optic rod may be carried by the tongue-retracting surface to assist in illuminating the oral cavity of the patient.

U.S. Pat. No. 5,152,686, issued Oct. 6, 1992 to Duggan, discloses a dental appliance which includes a bite block made of formable material, which includes a tongue stabilizer and a suction tube slidably and removably secured in the bite block for removing debris from the mouth cavity. The appliance may include a raised area for securing the appliance with the patient's teeth during performance of the dental procedures and a posterior vein located in the sidewall of the bite block with an aperture placed in the posterior vein for the suctioning of debris and saliva from the soft palate region of the mouth cavity behind the bite block. A slidably and removably secured rod for transmitting a fiber optic light source for illumination of at least a portion of the mouth cavity may also be included.

U.S. Pat. No. 4,802,851, issued Feb. 7, 1989 to Rhoades, indicates a dental appliance comprising a combination jaw rest and ejector having a generally hollow wedge-shaped body with upper and lower channels in which a patient's teeth rest and which holds open the patient's mouth. The wedge-shaped body is placed in the patient's mouth on the side opposite that on which work is being performed. A suction hose is attached to the body and the side of the body facing the work site is perforated so that a relatively high volume of air may be drawn into the body through the suction hose, thus drawing, with the air, blood, spray, and debris and substantially preventing the discharge of these materials, which may carry disease transmitting factors, from the patient's mouth. In one embodiment, the body includes perforated saliva collecting tube and/or a tongue depressor attached thereto. In a further embodiment, the body includes an illumination source therein to illuminate the interior of the patient's mouth. In another embodiment, a combination jaw rest and ejector includes an illumination source and is provided in a system which includes a combination air flow/light switch. In another embodiment, there is provided an illuminated jaw rest without means for evacuating material from the patient's mouth.

U.S. Pat. No. 4,991,566 issued Feb. 12, 1991 and U.S. Pat. No. 5,097,820 issued Mar. 24, 1992 both to Shulman, are for an articulating mouth-prop device for use in the diagnosis and/or treatment of patients suffering from trismus or other medical or dental problems or for other purposes. The device is for dilating and propping open a patient's jaws. The device includes a pair of outwardly-extending upper arms and a pair of outwardly extending lower arms. Each of the arms has a respective distal end which has a pad pivotally mounted thereon which contacts the patient's jaws during use thereof, and a respective proximal end, which is pivotably secured to the housing. Means is provided for pivoting the distal ends of the upper arms towards and away from the distal end of the lower arms such that the distal ends move substantially arcuately between the open and closed positions. A worm and worm wheel arrangement is provided for pivoting the arms, such that the spacing therebetween is infinitely variable. The device may have a cable and light source attached to the inner side of the upper arm.

U.S. Patent Application #20030208103, published Nov. 6, 2003 by Sonnenschein, concerns an entry port for endoscopes and laparoscopes, which comprises a device used to determine the depth of insertion and/or the angle of rotation of an elongated body passing through it. The device of the invention comprises at least one sensing element suitable to gauge the movement of the elongated body. In different embodiments of the invention the sensing element is selected from an optical sensor, a Hall effect sensor, or is a sensing element activated by mechanical friction. The device of the invention is especially suited use with endoscopic devices. In the case where the elongated body is a gastroscope, the device of the invention can be a modified bite block.

What is needed is a mouth prop that allows full view of the teeth and lights up the entire mouth of the patient.

### SUMMARY OF THE INVENTION

An object of the present invention is to provide a mouth prop for dental care to maintain a user's mouth fully open with a minimal thin ring structure of metal reinforced plastic providing a maximum central viewing area for a dentist to see the teeth needing attention and having an inwardly facing circular light in a recess on the interior of the ring for lighting up the entire mouth of the patient.

Another object of the present invention is to provide an inexpensively operated micro-fluorescent circular light, recessed on an inwardly facing side of the ring, for maximum light to light up the entire mouth without the need for high power external lamps which are expensive to operate, often ineffective, and provide heat and a glare in the patients' eyes.

One more object of the present invention is to provide a sanitized replaceable rubber guard around the outside of the ring to receive the teeth of the patient to prevent damage to the teeth biting on the ring.

An additional object of the present invention is to provide a concave recess around the outer perimeter of the ring covered by the rubber guard to receive the teeth of the patient in the rubber covered recess to hold the ring securely while preventing damage to the teeth.

A further object of the present invention is to provide a removable annular micro-fluorescent light and replaceable rubber guard which can both be removed after use to sanitize the ring and then the light and a new sanitized rubber guard installed for use with a new patient providing an easy-to-use and sanitize annular mouth prop.

In brief, the mouth prop of the present invention comprises a minimal thin ring, configured for a wide range of mouth sizes, having an outer concave trough for receiving the teeth and a large circular central opening encircled by a metal reinforced plastic frame with an annular micro fluorescent light attached to an inward facing side of the frame and an outer sanitized replaceable rubber guard that surrounds the frame. The light and outer rubber guard are removed for sanitizing the ring after each use and the light and a new sanitized rubber guard placed on the ring for a new patient.

An advantage of the present invention is that it maintains a patient's mouth fully open and provides a maximum central viewing area for a dentist to see the teeth needing attention.

Another advantage of the present invention is that it provides an inexpensively operated micro-fluorescent circular light for maximum light of the entire mouth.

One more advantage of the present invention is that it provides a sanitized replaceable rubber guard to prevent damage to the teeth biting on the ring.

An additional advantage of the present invention is that it receives the teeth of the patient securely while preventing damage to the teeth.

A further advantage of the present invention is that it provides an easy-to-use and sanitize annular biting block.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a front elevational view of the mouth prop of the present invention showing how an electric cord may exit the ring;

FIG. 2 is a back elevational view of the mouth prop of the present invention showing the micro-fluorescent light;

FIG. 3 is a side elevational view of a mouth of a user showing the device between opposing upper and lower teeth;

FIG. 4 is a cross-sectional view taken through the centerline showing the various components comprising the device of FIG. 1;

FIG. 5 is an edge view of the invention of FIG. 1.

### BEST MODE FRO CARRYING OUT THE INVENTION

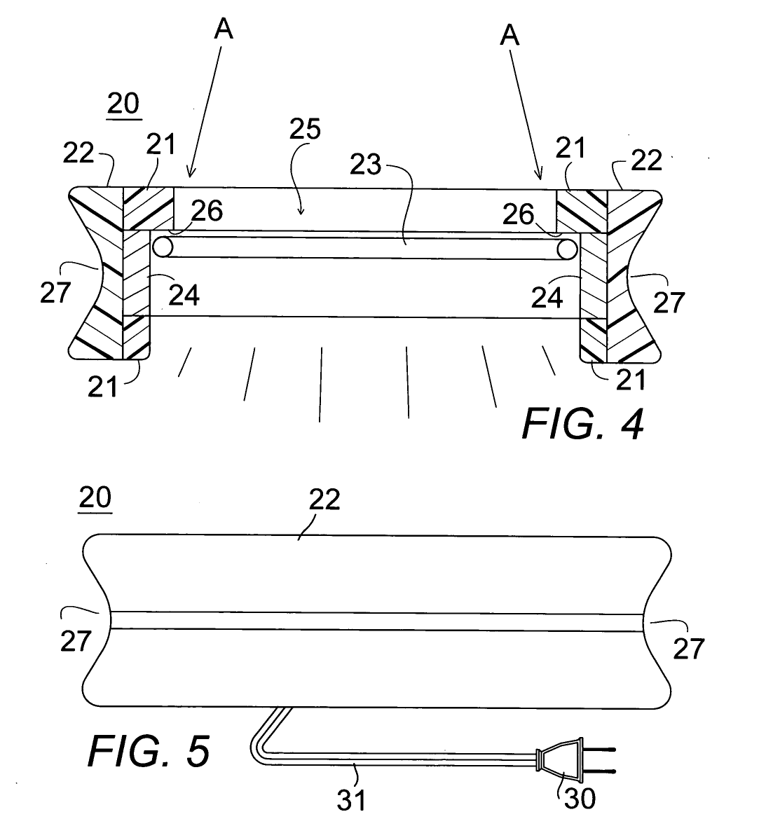

In FIGS. 1-5, the present invention comprises a mouth prop device 20 for use in dental care for holding open a mouth of a user which device provides maximum viewing area and lights up an entire mouth. A ring 21 formed of rigid material is configured to fit a wide range of mouth sizes. The ring 21 has a much larger central opening 25 than the radial thickness of the ring 21 to provide a full view inside a mouth through the central opening, as illustrated by the downwardly angled arrows AA of FIG. 4.

The ring 21 comprises an outer concave recess 27 around an outside perimeter of the ring for receiving opposing upper and lower teeth of a user fitting in the recess to support a mouth of a user in an open position, as seen in FIG. 3.

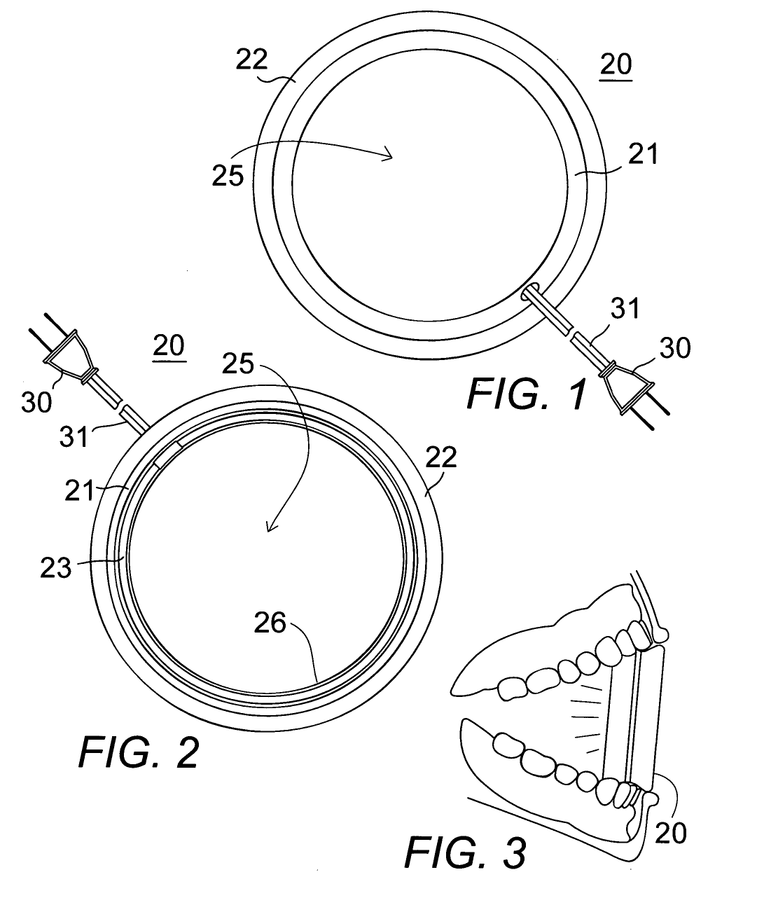

As seen in FIGS. 2 and 4, an annular micro fluorescent light 23 is attached in an annular recess 26 around the central opening 25 on a side facing an inside of a mouth, shown by radiant lines in FIGS. 3 and 4. The light 23 is removably attachable within the annular recess 26. An outer sanitized rubberized guard 22 is replaceably stretchable around and adapted for covering the outside perimeter of the ring including the concave recess 27. The concave recess 27 is preferably formed in the rubberized guard 22 which extends the perimeter of the ring 21 or formed in the ring itself and covered with the rubberized guard 22 over and conforming to the recess maintaining the same recess 27 around the outside perimeter of the ring.

Both the light 23 and the rubber guard 22 are adapted to be removable for sanitizing the ring 21 after each use and the light 23 and a new sanitized rubber guard 22 are adapted to be placed on the ring 21 for a new patient.

The ring 21 is preferably formed of a rigid synthetic material, such as a rigid plastic and comprises a core of rigid metal 24 to insure the strength of the ring and enable a minimal radial thickness for a maximum central opening 25.

In use, as seen in FIG. 3, the mouth prop device 20 is placed between opposing upper and lower teeth with the teeth in the concave recess 27 so that the device will not slip out. The light faces inwardly, as shown by the radiant lines, lighting the entire mouth. A dentist or hygienist can then work on the teeth with good lighting from the light 23 and easy viewing of the teeth through the central opening 25. After use, the rubber guard 22 and the light 23 are removable for sanitizing the ring and the light and a new sanitized rubber guard are placed on the sanitized ring and used for another patient.

It is understood that the preceding description is given merely by way of illustration and not in limitation of the invention and that various modifications may be made thereto without departing from the spirit of the invention as claimed.

1. A mouth prop device for use in dental care for holding open a mouth of a user which device provides maximum viewing area and lights up an entire mouth, the device comprising:
a ring formed of rigid material configured to fit a wide range of mouth sizes, the ring having a much larger central opening than the radial thickness of the ring to provide a full view inside a mouth through the central opening, the ring comprising an outer concave recess around an outside perimeter of the ring for receiving opposing upper and lower teeth of a user fitting in the recess to support a mouth of a user in an open position, an annular micro fluorescent light attached to a side of the ring facing into a mouth of a patient, and an outer sanitized rubberized guard replaceably stretchable around and adapted for covering the outside perimeter of the ring including the concave recess.

2. The device of claim 1 wherein the light and the rubber guard are adapted to be removable for sanitizing the ring after each use and the light and a new sanitized rubber guard are adapted to be placed on the ring for a new patient.

3. The device of claim 1 wherein the ring comprises a core of rigid metal.

4. The device of claim 3 wherein the ring further comprises a synthetic material covering the core.

5. The device of claim 4 wherein the ring has an annular recess around the central opening on a side facing an inside of a mouth and the light is removably attachable within the annular recess.
